(19) United States
(12) Patent Application Publication
(10) Pub. No.: US 2013/0170498 A1
(43) Pub. Date: Jul. 4, 2013

(54) ETHERNET FOR AVIONICS

(71) Applicants: Torkel Danielsson, Linkoping (SE); Anders Pettersson, Linkoping (SE); Anders Gripsborn, Ljungsbro (SE); Jan Håkegård, Linkoping (SE)

(72) Inventors: Torkel Danielsson, Linkoping (SE); Anders Pettersson, Linkoping (SE); Anders Gripsborn, Ljungsbro (SE); Jan Håkegård, Linkoping (SE)

(73) Assignee: SAAB AB, Linkoping (SE)

(21) Appl. No.: 13/704,863

(22) PCT Filed: Jun. 17, 2010
(86) PCT No.: PCT/SE2010/050684

§ 371 Date: Mar. 8, 2013

(51) Int. Cl. H04L 12/56

(52) U.S. Cl. CPC H04L 47/826
USPC 370/400

(57) ABSTRACT

An avionics switched Ethernet network. A plurality of synchronized interconnected system nodes each includes an avionics module arranged to periodically provide a set of data messages. Each message includes a set of data variables. A network module couples the avionics module to the network. The network module includes a network interface unit arranged to provide for transmission of data packets including a number of the data messages from the avionics module. The network module of each system node includes a transmission control unit arranged to control the network interface unit to perform scheduled transmissions of the data packets. The transmission control unit is provided with access to a memory module. Each of the plurality of time-slots is statically allocated a predetermined number of data packets, each including a predetermined subset of data messages from the set of data messages.

### TECHNICAL FIELD

The present invention relates to a system and a method for communication networks in avionics.

### BACKGROUND OF THE INVENTION

In embedded control systems of today, developments in digital technology have enabled complex functionality. However as a direct result from the development, the need of additional system capacity provided by software and various components such as sensors, processors, display units, data buses and memory units is increasing.

Apart from implementing more functionality and interconnectivity in control systems, using less Space Weight and Power, (SWaP) and a reduced number of cabling are further important drivers. Updates of embedded hardware and software during a products life span make adaptability and modularity another interesting design parameter. Other incentives include achieving cost efficient development, production and maintenance, where one possible route is to implement Commercial Off-The-Shelf (COTS) technology instead of expensive specialized technology.

Real-time systems for critical control applications, wherein typically data from sensor/s are acquired, communicated and processed to provide a control signal to at least an actuator pose strict demands regarding bandwidth, data delivery time, redundancy, and integrity. Failure to meet one or several of these demands can in applications including “brake-by-wire” or “steer-by-wire” prove potentially dangerous.

One such area wherein reliable high-speed real-time communication is of outmost importance is within avionics systems. Advances in technology during late 1960 and early 1970 made it necessary to share information between different avionics subsystems in order to reduce the number of functional modules such as Line Replaceable Units (LRU:s). A single sensor such as a position sensor provided information to weapon systems, cockpit display system, autopilot and navigation system. The subsystems communicated with one or several processing units using dedicated standardized avionics communication protocols. Early communication protocol includes the military MIL-STD-1553 and the commercial Aeronautical Radio Inc. (ARINC) 429 standard. ARINC 429 is a simplex point-to-point protocol with limitation in maximum data transmission speed of 100 Kbps and maximum number of connections limited to 20 receivers. In a system with many components requiring access to each other, this easily leads to excessive wiring and thereby increased weight, cost and complexity. MIL-STD-1553 is a protocol wherein the communication is half duplex and asynchronous with a data transmission speed of 1 Mbps. In an avionics system of today with high bandwidth requirement due to for example video processing resulting from increased use of image generating sensors, bandwidth of earlier protocol can prove insufficient. Avionics Standard Communication Bus (ASCB) by General Aviation Manufacturers Association (GAMA) provides a synchronized network protocol standard providing each component attached to the network a guaranteed amount of bandwidth. The ASCB protocol typically provides a data transmission speed of 10 Mbps.

Recently incentive has been raised within the field of avionics to implement more and more COTS hardware and software to reduce the need of specialized solutions with resulting higher cost.

COTS communication protocol standards that offer high bandwidth include Institute of Electrical and Electronics Engineers (IEEE) 802.3 Ethernet, Universal Serial Bus (USB), IEEE 1394 Firewire, Fibre Channel (FC) developed by the InTernational Committee for Information Technology Standards (INCITS) and Fibre Distributed Data Interface (FDDI). Ethernet have been around for more than 30 years and employed for data transmission applications such as internet access, multi-media, local office networks and other general purpose network solutions. However standard Ethernet was not originally developed with safety critical applications in mind. Transmitted data have no guarantee to arrive at an intended receiver and may thus have to be retransmitted.

Ethernet have recently started to be employed for communication purposes within avionics systems. Standards including ARINC 664 and the closely linked Avionics Full Duplex switched Ethernet (AFDX) presents protocols for communication in avionics using Ethernet. AFDX provides a protocol with a statistically bounded latency where the bandwidth is divided and each sender is provided a guaranteed bandwidth. Despite the latency being bounded by the protocol standard, it is still variable. Dedicated AFDX switches are also required when implementing an AFDX network.

EP 1841138 A2 discloses a method and system for controlling synchronous and asynchronous Ethernet communication in an avionic system. The synchronous messages are allocated to corresponding predetermined time-slots and the asynchronous messages are allocated to the one or more unoccupied portions of the predetermined time-slots.

However, moving from dedicated communication protocols in attempts to reduce costs and increase bandwidth tends to decrease determinism.

Accordingly, there is a need of an improved communication system and method in order to be able to reliably transfer data requiring high bandwidth between various avionics components in real-time.

### OBJECTIVE OF THE INVENTION

It is therefore an objective of the present invention to provide a system and a method, which offer high bandwidth and increased determinism in regard of the data traffic within an avionics communication network.

### SUMMARY OF THE INVENTION

This object is achieved according to the present invention by an avionics switched Ethernet network, for communication of data, the network comprising: a plurality of synchronized interconnected system nodes each comprising: an avionics module arranged to periodically provide a set of data messages, each comprising a set of data variables related to avionics functions, a network module coupling the avionics module to the network said network module comprising a network interface unit arranged to provide means for transmissions of data packets comprising a number of said set of data messages from said avionics module. The network module of each system node comprise a transmission control unit arranged to control the network interface unit to perform scheduled transmissions of said data packets, wherein said transmission control unit is provided with access to memory means comprising scheduling information relating to a timing table comprising a plurality of time-slots of predetermined duration within at least one periodically repeating communication time frame, wherein each of said plurality of time-slots is statically allocated a predetermined number of data packets, each comprising a predetermined subset of data messages from said set of data messages.

By this is achieved a communication network that is deterministic and is able to bound latency.

The system is in one option further characterized in that the scheduling information is based on determined end-to-end communication delay constraints associated to communication of the data messages between processes allocated to different system nodes (N1-N3)

The system is in one option further characterized in that the scheduling information is determined off-line on basis of communication requirements, determined from execution characteristics of at least one process associated to each of the system nodes, said at least one process arranged to periodically provide at least one data message of said set of data messages.

The system is in one option further characterized in that the avionics module of each system node is arranged to periodically provide data messages of the set of data messages at a plurality of different period times and wherein the duration of each of the at least one communication time frames is preselected based on the shortest period time of the plurality of different period times.

The system is in one option further characterized in that the scheduling information is configured so as to prevent time-slot over-run wherein at least one of the data packets is transported on the network for a plurality of consecutive time-slots.

The system is in one option further characterized in that at least one system node is arranged to transmit synchronization data packets to the other system nodes.

The system is in one option further characterized in that the network comprises a dual redundant switched Ethernet network topology and each of the system nodes are arranged to transmit data packets along two independent paths formed in the network based on a plurality of traffic control means.

The system is in one option further characterized in that the transmission control unit is arranged on top of IEEE 802.3 Ethernet conformant physical layer.

By this is achieved a communication system that is a cost effective by means of the ability to operate using standard Ethernet physical layer components such as for example standard network interfaces, switches and cables.

This objective is also achieved according to the present invention by a method for controlling transmissions in an avionics Ethernet network the method comprising the steps of: providing periodically a set of data messages, each comprising a set of data variables related to avionics functions, transmitting at least one synchronization message onto the transmission medium, detecting the beginning of at least one periodically repeating communication time frame comprising a plurality of time-slots of predetermined duration, based on the at least one synchronization message, perform scheduled transmissions of said data packets, based on scheduling information relating to a timing table statically allocating to each of said plurality of time-slots a predetermined number of data packets, each comprising a predetermined subset of data messages from said set of data messages.

The dependent claims define optional characterizing features corresponding to those described in relation to the system.

This objective is also achieved by a computer programme comprising a programme code for performing the above described method steps, when said computer programme is run on a computer.

This objective is also achieved by a computer programme product comprising a program code stored on a computer readable media for performing the above described method steps, when said computer programme is run on the computer.

This objective is also achieved by a computer programme product directly storable in an internal memory of a computer, comprising a computer programme for performing the above described method steps, when said computer programme is run on the computer.

### BRIEF DESCRIPTION OF THE DRAWINGS

FIG. 1. shows schematically a block diagram of the communication system for avionics.

FIG. 2. shows schematically a time-slot scheme according to an example of the present invention.

FIG. 3. illustrates schematically a time and traffic schedule of the communication system for avionics according to an example of the present invention.

FIG. 4. shows schematically a block diagram of the communication system for avionics according to an example of the present invention.

FIG. 5. shows schematically a method of communicating according to an example of the present invention.

### DETAILED DESCRIPTION

The following examples relates to the case where a communication system is described with reference to aerial vehicles. However, various different applications are possible, e.g. for use in land, sea or space vehicles.

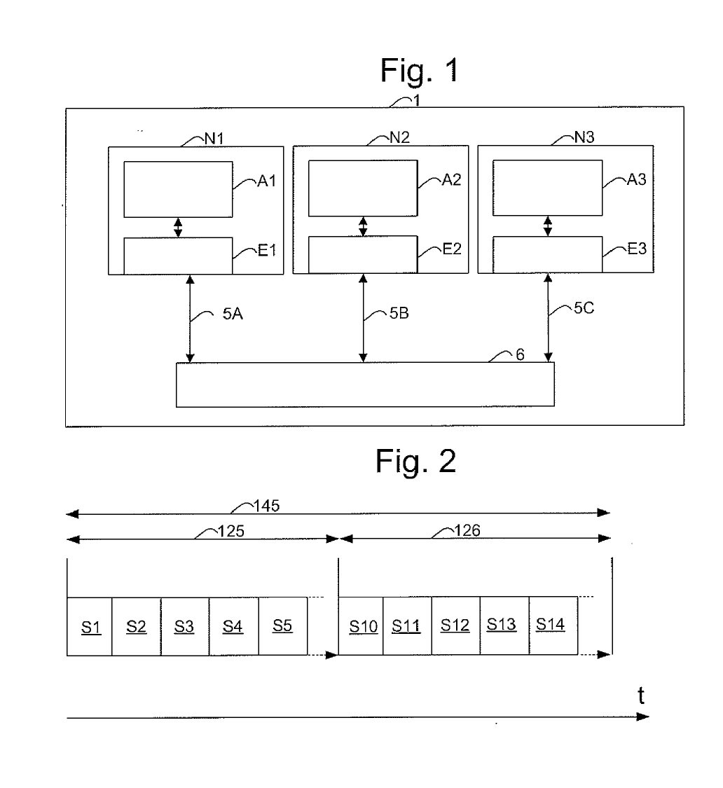

Referring to the drawings, and initially to FIG. 1, there is illustrated a block diagram of a communication network 1 in accordance with an example of the present invention. The communication network 1 also referred to in the description as the communication system comprises bidirectional transmission links 5A-5C, communicatively connecting a plurality of system nodes N1-N3, via a switch 6. The communication network 1 is configured to provide means for communication of data packets comprising units of data arranged in data messages between the system nodes N1-N3. The communication network 1 is based on standard Ethernet physical layer conformant with IEEE 802.3, such as for example 100 BASE-TX and/or 1000 BASE-T or the like. Each system node N1-N3 comprises an avionics processing component A1-A3 coupled to a network component E1-E3. Each of the avionics processing components A1-A3 may be a line replaceable unit (LRU). A LRU describes units such as for example a flight control computer (FCC), an integrated modular avionics (IMA) unit, a display computer, an autopilot or the like. Each of the network components E1-E3 is arranged to perform one or more operations related to timing, data conversion, message encapsulation, message de-capsulation, data transmission and data reception. The network components E1-E3 of each system node N1-N3 may for example be coupled to via an internal bus structure associated to the avionics processing components A1-A3 such as for example a PCI, PCIe, IDE or the like in order to perform read and or write operations regarding units of data stored in one or more memory components associated to the avionics processing component A1-A3. The data messages may each comprise one or more units of data also referred to as variables, related to for example, a sensor reading, a periodically calculated output value of a control loop or the like. A data packet may be forwarded in the network from one or a plurality of sending nodes to one or a plurality of designated receiving nodes. Each of the nodes N1-N3 may interchangeably send and receive data packets. Access to the network 1 is restricted for each node N1-N3 on basis of a time triggered media access protocol. This means that each node N1-N3 is permitted to perform transmissions of one or more data packets during a particular allocated period of time i.e. time-slot.

Each of the data message intended to be transmitted from each of the system nodes N1-N3 is encapsulated before transmission into one or more Ethernet data packet. The data packet may comprise a header field, an application data field and a fault detection field. The header field may be provided with information related to identification of sending node and receiving node. The application data field may be provided with application data from the sending node such as for example message data comprising the result of a calculated control loop. The fault detection field may be provided with error correcting code (ECC) and/or checksum.

In one example to indicate what particular data message is being transmitted and received, User Datagram Protocol (UDP) port numbers may be used to identify each data message and where to place the units of data provided in each of said data message. Hence, the network component E1-E3 of each system node N1-N3 may use the UDP port numbers to identify the correct place i.e. memory address to perform read and/or write operations regarding data messages and associated one or more units of data stored in one or more memory components associated to the avionics processing component A1-A3

In one example the data packets may be transmitted from each of the system node N1-N3 using point-to-multipoint communication i.e. multicast, referring to sending data packets to a group of system nodes. As an example system node N1 may be arranged to multicast data packets to a system group comprising the system nodes N2 and N3.

The switch 6 is in one example a standard Ethernet switch comprising a plurality of data ports. The switch 6 may comprise a processor, a plurality of input and output ports each associated with one of the system nodes N1-N3. Upon reception of the data messages the switch 6 may be arranged to store the received data messages in one or more input buffer memory devices. The processor of the switch 6 may be arranged to route the received data messages from the input buffer memory devices to output buffer memory device associated with one or more designated receiving system node N1-N3. The designated one or more receiving system nodes may be read by the switch by means of destination addresses encapsulated by the sending node in each of the data packets. The addresses may be Media Access Control (MAC) addresses, defining one address for each transmission link 5A-5C coupling the system nodes N1-N3 to the switch 6. The switch 6 may then be able to correctly identify the designated one or more receivers of each data packet by means of indentifying the address in a static lookup table provided in an internal memory of the switch 6. The lookup table may then provide the correct one or more output ports to route the received data to. Configuration of the switch 6 may be performed by uploading a new version of the lookup table to the internal memory of the switch 6.

In the illustrated example with reference to FIG. 1 the communication system comprises three system nodes N1-N3 and one switch 6, however other examples may comprise a number of additional system nodes and/or switches connected with standard Ethernet links.

In one example the time triggered media access protocol may be implemented in the network component E1-E3 of each system node N1-N3. Each system node N1-N3 may transmit data packets simultaneously onto the network in accordance with the time triggered media access protocol. Each member of the communication network i.e. system nodes N1-N3 may be pre-assigned to predetermined points in time i.e. when it should transmit data packets and further points in time when it can expect to receive data packets. The predetermined points in time may be detected and maintained by software arranged in each of the system nodes N1-N3 such as for example by a driver associated to a programmable interrupt timer. To be able to execute the time triggered schedule each of the system nodes may be arranged to maintain time by means of local hardware and/or software time keeping devices or a combination thereof.

With reference to FIG. 2 the time triggered media access protocol may be defined by a cyclic i.e. repeating schedule comprising a major communication cycle 145, comprising a set of minor communication cycles 125, 126 each comprising a number of time-slots S1-S5, S10-S14 of predetermined duration. At detection of the start of a time-slot, each system node may be arranged to transmit its allocated one or more data packets one after another.

As an example each time period such as for example each 1 second time period may be configured to be divided into 20 equally sized 50 ms time-slots. The major cycle may comprise a number of minor cycles i.e. sets of said configured 50 ms time-slots. In case the major cycle comprise three minor cycles then corresponding major cycle is 3 seconds long. After the major cycle is completed it may be repeated indefinitely or until shutdown of system.

In one example each system node N1-N3 may be provided with a fixed traffic schedule. The fixed traffic schedule may comprise one or more tables of entries associating each of the time-slots with one or more corresponding data messages to transmit in at least one data packet.

The fixed i.e. preconfigured traffic schedule may in one example be stored on a memory portion of a memory associated to the network module of each of the respective system nodes. Each of the system nodes N1-N3 connected to the network may by means of the fixed traffic schedule statically be allocated zero or more packets to transmit in each time-slot of a series of subsequent time-slots in accordance with the time triggered media access protocol. Hence, at each instant of time the traffic of data packets is known to all system nodes.

In one example the fixed traffic schedule may be determined on basis of the communication requirement of each system node N1-N3. Each system node may be arranged to periodically perform one or more functions associated with various avionics systems such as for example calculating one or more control loops. Each function of each of the system nodes N1-N3 may be divided into a set of periodic tasks also referred to as processes. Each task may be defined by a set of characteristics with respect to timing. Each task may require a specific number of processor cycles constituting an execution time (ET). Each task may further be defined by a worst case execution time (WCET) wherein said WCET is generally longer than the ET based on the actual physical processing including operations such as for example task release, start, preemption, resume, completion and termination. One or more of the periodic task may further be dependent on one or more units of data provided by one or more other tasks which is arranged to execute on different avionics processing components A1-A3. These one or more periodic tasks need to be scheduled regarding communication of data on the communication network 1.

In one example one or more associated data messages provided from each periodic task may be determined to be scheduled for communication in one or more data packets to be transmitted on the network 1 in a specific time-slot based on the associated execution period of each of the tasks. As an example each task may arranged to communicate at a periodic basis with respect to the period associated to each task.

In one example each of the periodic tasks one or more associated data messages provided from each periodic task may be determined to be scheduled for communication in one or more data packets to be transmitted on the network 1 in a specific time-slot based on the associated execution period of each of the tasks and communication delay constraints associated to each of the tasks. The communication delay constraints may be imposed on each task by means of one or more tasks being dependent on units of data provided as communication between several tasks. As an example a first task executing on a first system node N1 may be arranged to transmit one or more associated data messages comprising one or more units of data in one or more time-slots, such that the one or more units of data provided by the first task is available for processing by a second task executing periodically on a second system node N2 before a scheduled release time of said second task.

In one example each task arranged to provide units of data associated to data messages may be pre-assigned a task execution period time selected from a set of system global task periods. Hence, communication by means of the network 1 between a plurality of system nodes and tasks executing on said system nodes may be co-scheduled based on period time, WCET and delay constraints associated to each of the tasks. In order to provide means for periodic communication of data messages provided from each task the minor communication time frame may be adapted to correspond to the shortest task period time of the set of system global task periods.

In one example the size of each data message is considered with respect to the available bandwidth of the network 1 when determining the allocation of data messages to be transmitted in time-slots of the fixed traffic schedule.

Worst case transmission time WCT need to be considered when determining the fixed traffic schedule. The WCT may be referred to as the time from when a particular unit of data is produced by completion of an instance from a first task and is ready for transport until the time when the particular unit of data has been transported and is ready for processing by an instance of a second task. The actual transmission time may vary from time to time based on variation in the arrival or departure times referred to as jitter caused by switches, input/output processing and configuration of physical transmission medium etc. Parameters that may affect the WCT may for example include type and length of cabling along the respective intended data packet routing and the policy and performance of the switch regarding memory access, the amount of data traffic and processing power. The WCT may be determined according to the following equation.

WCT=S_{P}+P_{R1}+S_{w}+P_{R2}+R_{P}

Wherein S_{P} denotes time it takes for the respective system node N1-N3 to process operations related to transmission of data messages, wherein P_{R1} and P_{R2} denotes propagation delay inflicted by transmitting electrical signals corresponding to data packets along cables to and from the switch. S_{w} denotes delay inflicted by queuing and routing the data packets in the switch. R_{P} is the time it takes for the respective system node N1-N3 to process operations related to receiving data packets and retrieving data messages from said data packets.

In one example the fixed traffic schedule may be determined based on preventing time-slot over-run wherein a data message is transported on the network 1 for a plurality of consecutive time-slots. By the use of the condition the design of the communication system is able to bound worst case transmission delay.

By considering the communication requirements of the each of the respective system nodes and the physical properties of the communication network 1 the time triggered traffic schedule may be determined off-line.

The specific time triggered traffic schedule may be determined by hand or by means of scheduling software executed on a computer. After the time triggered traffic schedule is determined it may subsequently be transformed into instructions readable by a computer such as for example compiled into a binary format.

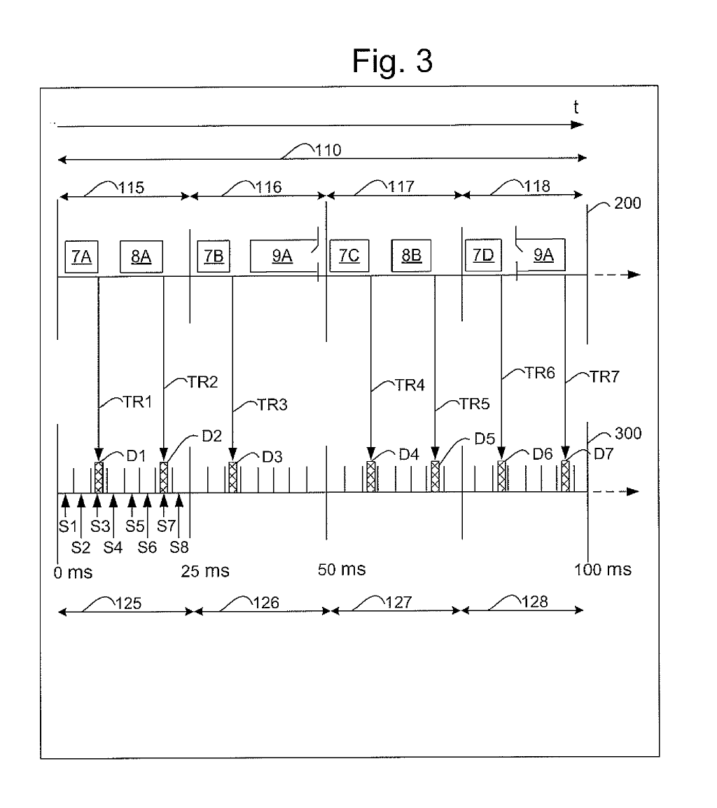

For purpose of illustration with reference to FIG. 3 a first system node N1 may be arranged to periodically execute instances of a first task 7A-7D, instances of a second periodic task 8A-8B and instances of a third periodic task 9A according to a cyclic execution schedule 200 defined by a major execution cycle 110 comprising a number of minor execution cycles 115-118. A second node N2 may be arranged to execute a first set of tasks being dependent on units of data provided by the instances of the first 7A-7D and second task 8A-8B. The instances of the first task 7A-7D may be arranged to produce an output i.e. units of data corresponding to “positional data” on a 40 Hz basis from using information provided by an inertial measurement unit IMU. The instances of the second periodic task 8A-8B may be arranged to produce an output corresponding to a “position report message” on a 20 Hz basis. The instances of the third periodic task 9A may be arranged to produce an output corresponding to a “distance to closest obstacle” on a 10 Hz.

Each instance of the first, second and third tasks may for example be defined by the following characteristics regarding worst case execution time WCET, worst case transmission time WCT and task frequency as illustrated by Table 1.

TABLE 1

| Task | Frequency | Period | WCET | WCT |
|---|---|---|---|---|
| First | 40 Hz | 25 ms | 5 ms | N1-N2 6 ms |
| Second | 20 Hz | 50 ms | 6 ms | N1-N2 6 ms |
| Third | 10 Hz | 100 ms | 25 ms | N1-N2 6 ms |

Tasks associated to each of the respective first and second system nodes N1-N2 in the example may be arranged to synchronously execute in priority order based on task frequency i.e. task period in accordance with execution schedules such as for example execution schedule 200 comprising a major cycle 110 and a number of minor cycles 115-118. The instance of the first task 7A-7D may be arranged to execute first in order each 25 ins time period. The instances of the second task 8A-8B may be arranged to execute second in order in each 50 ins period and the instances of the third task 9A may be arrange to execute third in order in each 100 ins period. The instances of the third task 9A may be preempted during a second minor cycle 116 and resumed in a fourth minor cycle 118 due to its associated WCET risk exceeding its allocated execution time as defined by schedule 200. To construct a corresponding preconfigured traffic schedule 300 each of the minor execution cycles 125-128 of the execution schedule 200 may be divided into a number of time-slots S1-S8 each corresponding to a predetermined time period. In the shown example the time period each of the minor execution cycles are divided into eight time-slots S1-S8 each corresponding to a time period of 3.125 ins.

Each of the units of data i.e. output results from processing instances of the first, second and third task may be scheduled for transmission TR1-TR7 in one or more data packets D1-D7 in one or more corresponding time-slot S1-S8 associated to one or more of the minor communication cycles 125-128. The transmissions TR1-TR7 may be scheduled based on time of completion of the task performed by a system node N1-N2 and based on points in time relating to when a particular data message comprising one or more units of data i.e. particular output results of said task is needed by one or several other tasks and/or other systems coupled to the communication network 1. Additional factors that may be considered is the amount of time S_{P} needed for process operations related to transmission of data messages in a transmitting node.

The WCT from the first node N1 to the second node N2 may be determined to be 6 ms. Delay constraints for transmission of units of data from instances of the first and second task may be determined to be that the units of data from all transmitted data messages need to be ready for processing in the one or more receiving system nodes no later than at the end of the period wherein which the unit of data is provided. A first transmission TR1 may represent a first transmission of output data from a first instance of the first task 7A via the network 1 to one or more of the second. The first transmission TR1 may be scheduled in one or more of the time-slots starting from the first upcoming time-slot after its time of completion. However to fulfill the condition of tasks associated to the second node being dependant on one or more output values from a previous execution period associated to the task providing the units of data the worst case transmission time to the second node needs to be considered when scheduling the first transmission TR1. Transmissions from instances of the first task 7A-7D may then accordingly be scheduled into any time-slot ranging from a third time-slot S3 to a sixth time slot S6 of each minor communication cycle 125-128, such as for example in the third time-slot S3 of each the minor communication cycles 125-128, corresponding to four periodic transmissions illustrated in FIG. 3 as first, third, fourth and sixth transmission TR1, TR3, TR4 and TR6. A second transmission TR2 may represent a transmission of output data from instances of the second task 8A-8B to the second node. The constraint for the second transmission TR2 may be determined from the WCET, period time associated to instances of said second task and the WCT to the second node. Accordingly, the second transmission TR2 may be scheduled into any time-slot ranging from a seventh time-slot S7 of the first minor cycle 125 until a sixth time-slot S6 of a second minor cycle 126, such as for example in the seventh time-slot of the first minor communication cycle 125. Subsequently a fifth transmission TR5 may be scheduled in the seventh time-slot S7 in the third minor cycle 127. Note that there is no constraint presented for the illustrated seventh transmission TR7 representative of a transmission of a data message comprising an output value form an instance of the third task 9A.

The corresponding preconfigured traffic i.e. communication schedule 300 may be repeated indefinitely in synchronicity with the task execution schedule 200.

In one example the first time-slot S1 of each minor cycle 115-118 in the communication schedule 300 may be assigned to a synchronization data packet. The last time-slot S8 in each of the minor cycles 115-118 may be configured as a “dead band” also referred to as a refusal window in order to provide separation between subsequent minor cycles 115-118.

It should be understood that the communication system with reference to the above example including three tasks, each described with a specific timing requirements may be configured differently. Differences may include that the number of tasks differ, each of the tasks may transmit more than one data message and the tasks may be dependent on more than one different task or other system connected to the communication network 1.

In one example a common time reference also referred to as local avionics system time (AST) is provided. To be able to effectively implement the time triggered media access protocol, restricting the access to the transmission medium it is important that all nodes N1-N3 in the communication system 1 have one and the same view of time, To maintain substantially the same view of system time among the system nodes, a synchronization protocol may be implemented in the system.

In one example synchronization data packets indicating the start of the minor cycle are sent on a cyclic basis from a master node, such as from a flight management computer (FCC) configured for flight safety critical operations. The synchronization data packets are received by the system nodes whereby each receiving node can use the synchronization packet to detect if is out of sync and respond by re-synchronizing its respective local clock.

The master node may in one example be provided with a high quality time keeping device such as a high quality crystal oscillator, or be synchronized to external high quality time keeping devices such as by means of receiving Pulse per Second (PPS) signals from atomic clocks featured in Global Positioning Systems (GPS). The latter may be beneficial in case the communication system involves system nodes that perform calculations involving positioning or other calculations that are performed on basis of an external global time value, such as Greenwich Mean Time (GMT).

In one example the system nodes may be synchronized in time using the IEEE 1588, standard for a precision clock synchronization protocol for networked measurement and control systems.

In one example the system nodes may be arranged to operate on basis of a fail silent protocol. The fail silent protocol is based on that only system nodes that are substantially synchronized in time i.e. within a tolerance level in respect of the AST may be arranged to transmit data packets. As soon as each of the system nodes is able to resynchronize, the respective system nodes may be allowed to transmit its data packets according to the schedule. This means that effects of local clock jitter, drift or effects resulting from a system startup procedure of each system node may not affect transmitting packets being out of sync with respect to the predefined schedule.

In one example the handling of input/output (I/O) processes in correspondence to the preconfigured traffic schedule may within each system node N1-N3 be performed by partitioned software executed on an IMA computer.

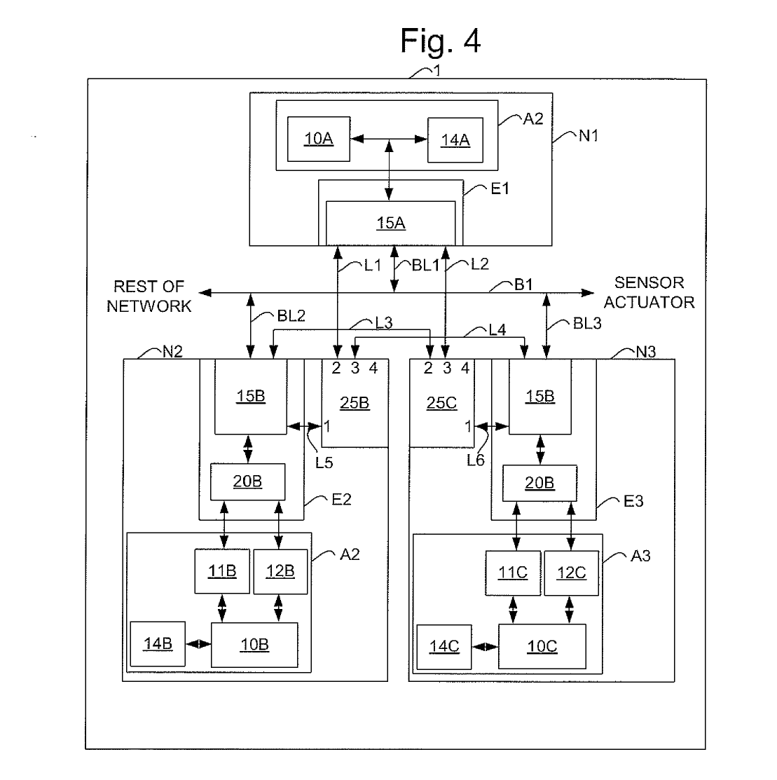

In one example the communication system with reference to FIG. 4 comprise three system nodes N1-N3 arranged in communicative operation by means of a plurality of Ethernet links L1-L6 in a dual redundant configuration comprising two switches 25B and 25C. Each of the two switches 25B and 25C comprises four ports 1-4. The avionics component A1-A3 of each of the system nodes comprises a processor 10A-10C arranged to process one or more associated tasks in order to produce one or more data messages. Each of the processors of the avionics processing components is coupled to a program memory 14A-14C comprising processing instructions for executing said associated tasks. The processor of the second N2 and third N3 avionics component A1-A3 is further coupled to an input memory 11B-11C and an output memory 12B-12C to provide means for communication of said data messages. The system nodes N1-N3 comprise a network interface 15A-15C comprising an Ethernet socket and an Ethernet controller arranged to provide means for transmissions of data messages in one or more Ethernet data packets. The network interface 15A-15C of each system node may further comprise additional sockets and controllers to allow to be coupled to at least a secondary bus B1 by means of bus links BL1-BL3. The secondary bus B1 may be a MIL-STD-1553 bus providing connections to other parts of the network such as additional system nodes, sensors and/or actuators. The second and third of the system nodes N2, N3 are provided with an I/O data processor (TOP) 20B, 20C. The IOP 20B, 20C of the at least one system node may be arranged to be in operative connection with a portion of a memory comprising information relating to the preconfigured traffic data schedule. The IOP 20B, 20C of the at least one system node is arranged to be in operative connection with one or more input 11B-11C and/or output 12B-12C memory associated to data messages provided from tasks. The IOP 20B, 20C may be arranged to control all incoming and outgoing data transmissions from a system node N1-N3 based on the preconfigured traffic schedule. The IOP 20B, 20C may for example be arranged to implement timer services, such as for example periodic interrupts to trigger timed operations of the network interface 15A-15C in accordance with the preconfigured traffic schedule in providing units of data associated to one or more data messages from one or more portions of the associated output memory 12B-12C to the network. The IOP 20B, 20C of each system node N1-N3 may further for example be arranged to implement timer services to trigger timed operations in accordance with the preconfigured traffic schedule in providing data received from the network to one or more portions of the associated input memory 12B-12C. The timer services associated to several system nodes may be synchronized based on the synchronization data packets. The first system node N1 is arranged to perform control of its associated network interface 15A such as for example by means of an input/output software module stored in the program memory 14A and scheduled to execute periodically on its associated avionics processing component A1. The input/output software module is further arranged to operate in accordance with the preconfigured traffic schedule.

It should be understood that the example with reference to FIG. 4 may be configured differently regarding the associated switches, memory configuration and processors. For example each avionics processing component A1-A3 may comprise an associated TOP or alternatively several avionics processing components A1-A3 may share access to a single IOP.

In one example one or more of the system nodes N1-N3 may be configured to execute a partitioning operative system (OS), such as for example an OS compliant with the commercial Aeronautical Radio Inc. (ARINC) 653 specifications. This enables different applications to execute on separate partitions of a single processor, where the execution of each application is partitioned regarding execution time and memory space. Each process may be assigned a process execution frequency, whereupon the process is periodically executed. Each task or set of task may be associated to communication ports referred to as sampling port or queuing ports for communication of data messages comprising units of data.

In one example with further reference to FIG. 3 the communication system is based on two parallel identical networks including the two switches 25B, 25C and the Ethernet links, providing two independent communication channels between each of the system nodes. Each data packet transmitted from a sending node may be transmitted substantially in parallel on both channels. As an example the first system node N1 may be arranged to transmit its data packets to both channels. The network interface 15C of the third node then receives the data packets both via a first communication channel 15A-L1-25B-L4-25C and via a second communication channel 15A-L2-25C-L6. This means that each receiving node receives two copies of each transmitted data packet. The receiving node may be provided with a filtering device arranged to filter out copies of the received data packets.

In one example the sending node may be arranged to provide a sequence marking on the data packet before transmitting the data packet on the network. By providing each subsequent transmitted data packet with an incrementing sequence number the filtering device may be arranged to filter out copies by detecting non-incrementing sequence number of the received data packets. To reduce the number of bits in a packet necessary for the sequence number the incrementing sequence number can be subjected to a roll over at a predetermined sequence number.

In one example the filtering device may be arranged to filter out copies of the data packets on basis of detecting time of arrival. The filter may then be arranged to filter out the copy by discarding the data packet with the longer arrival time.

All data packets may be provided with a checksum at the sending node such as cyclic redundancy check (CRC) and/or other error correcting code ECC. The checksum can be verified at a receiving node to control integrity of the received data.

In one example the system nodes N1-N3 may each comprise a non-volatile memory, a data processing device such as a microprocessor and a read/write memory. The non-volatile memory has a first memory portion wherein a computer program, such as an operating system, is stored for controlling the function of the communication network 1. Further, the system nodes N1-N3 comprises a bus controller, a serial communication port, I/O-means, an A/D-converter, a time date entry and transmission unit, an event counter and an interrupt controller. The non-volatile memory also has a second memory portion.

A computer program comprising routines controlling transmissions in an avionics Ethernet communication network 1 is provided. The program may be stored in an executable manner or in a compressed state in a separate memory and/or in the read/write memory.

When it is stated that the data processing device performs a certain function it should be understood that the data processing device performs a certain part of the program which is stored in separate memory, or a certain part of the program which is stored in read/write memory.

The data processing device may communicate with a data port by means of a first data bus. The non-volatile memory is adapted for communication with the data processing device via a second data bus. The separate memory is adapted to communicate with data processing device via a third data bus. The read/write memory is adapted to communicate with the data processing device via a fourth data bus.

When data is received on the data port it is temporarily stored in the second memory portion. When the received input data has been temporarily stored, the data processing device is set up to perform execution of code in a manner described above. According to one example, data received on the data port comprises information regarding the detected time-slot and corresponding one or more specific data packets to transmit as determined from the preconfigured time triggered traffic schedule. This information can be used by the system nodes so as to control transmissions in an avionics Ethernet communication network, as described above.

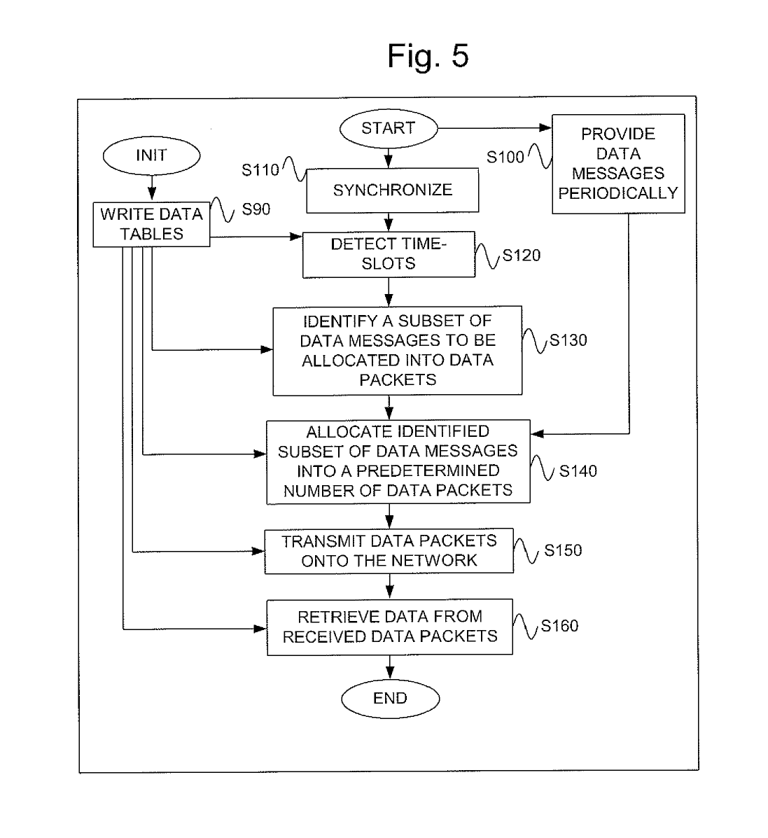

One example of the invention relates to a computer programme comprising a programme code for performing the method steps depicted with reference to FIG. 5, when the computer programme is run on a computer.

One example of the invention relates to a computer programme product comprising a program code stored on computer-readable media for performing the method steps depicted with reference to FIG. 5, when the computer programme is run on the computer.

One example of the invention relates to a computer programme product directly storable in an internal memory of a computer, comprising a computer programme for performing the method steps depicted with reference to FIG. 5, when the computer programme is run on the computer.

FIG. 5 schematically illustrates a flow diagram of a method according to an example of the present invention. This example relates to controlling transmissions of data messages from system nodes in the avionics Ethernet network 1.

In a first method step S90 associated to system initialization writing data tables is performed i.e. writing the preconfigured traffic schedule to the memory associated to the processor arranged to handle the input and output processing in each of the system nodes N1-N3. The first method step is generally only performed once in response to system modifications. After the method step S90 a subsequent method step S100 is performed.

In the method step S100 a set of data messages are provided by each of the system nodes. This means that each system nodes processes one or more periodic tasks resulting in that one or more data messages are provided periodically, each comprising one or more units of data. After the method step S100 a subsequent method step S110 is performed

In the method step S110 synchronization of the system nodes is performed. This means that a synchronization message is transmitted onto the network arranged to provide synchronization information to the system nodes. After the method step S110 a subsequent method step S120 is performed.

In the method step S120 a plurality of time-slots within at least one communication time frame are detected, i.e. each system node detects the beginning of an upcoming time-slot by determining if the elapsed time period since the prior time-slot was detected, corresponds to a predetermined value in the preconfigured traffic schedule or by determining if the elapsed time since a synchronization data message was received at the initialisation process corresponds to a predetermined value in the preconfigured traffic schedule. After the method step S120 a subsequent method step S130 is performed.

In the method step S130 a subset of data messages of the set of data messages provided by each system node to transmit in the detected time-slot is determined. Each detected time-slot corresponds to a point in time indicating a permission to transmit a predetermined subset of data messages as indicated by one or more entries in the data tables i.e. preconfigured traffic schedule.

In the method step S140 the subset of data messages determined to be transmitted in the time-slot is encapsulated into one or more Ethernet data packets. After the method step S140 a subsequent method step S150 is performed in the illustrated example.

In the method step S150 each of the system nodes N1-N3 transmit its one or more allocated Ethernet data packets. After the method step S150 a subsequent method step S160 is performed in the illustrated example.

In the method step s160 data from received Ethernet data packets is retrieved. Each system node may determine which data messages of which received Ethernet data packets to forward to the a particular memory address of the system node on basis of one or more entries in the preconfigured traffic schedule and data message identification information embedded in the Ethernet data packet. After the method step S160 the method ends and may be repeated starting with the method step S100 to perform a new controlled data transmission.

Many modifications and variations will be apparent to practitioners skilled in the art without departing from the scope of the invention as defined in the appended claims. The examples were chosen and described in order to best explain the principles of the invention and its practical applications, thereby enabling others skilled in the art to understand the invention for various examples and with various modifications as suited to the particular use contemplated.

1. An avionics switched Ethernet network, for communication of data, the network comprising:
a plurality of synchronized interconnected system nodes each comprising:
an avionics module arranged to periodically provide a set of data messages, each comprising a set of data variables related to avionics functions,
a network module coupling the avionics module to the network, said network module comprising a network interface unit arranged to provide for transmissions of data packets comprising a number of said set of data messages from said avionics module,
wherein the network module of each system node comprises a transmission control unit arranged to control the network interface unit to perform scheduled transmissions of said data packets, wherein said transmission control unit comprises access to a memory module comprising scheduling information relating to a timing table comprising a plurality of time-slots of predetermined duration within at least one periodically repeating communication time frame, wherein each of said plurality of time-slots is statically allocated a predetermined number of data packets, each comprising a predetermined subset of data messages from said set of data messages.

2. The network according to claim 1, wherein the scheduling information is based on determined end-to-end communication delay constraints associated to communication of the data messages between processes allocated to different system nodes.

3. The network according to claim 1, wherein the scheduling information is determined off-line on basis of communication requirements, determined from execution characteristics of at least one process associated to each of the system nodes, said at least one process arranged to periodically provide at least one data message of said set of data messages.

4. The network according to claim 3, wherein the avionics module of each system node is arranged to periodically provide data messages of the set of data messages at a plurality of different period times, and wherein the duration of each of the at least one communication time frames is preselected based on the shortest period time of the plurality of different period times.

5. The network according to claim 1, wherein the scheduling information is configured so as to prevent time-slot over-run wherein at least one of the data packets is transported on the network for a plurality of consecutive time-slots.

6. The network according to claim 1, wherein at least one system node is arranged to transmit synchronization data packets to the other system nodes.

7. The network according to claim 1, wherein the network comprises a dual redundant switched Ethernet network topology and each of the system nodes are arranged to transmit data packets along two independent paths formed in the network based on a plurality of traffic control modules.

8. The network according to claim 1, wherein the transmission control unit is arranged on top of IEEE 802.3 Ethernet conformant physical layer.

9. A method for controlling transmissions in an avionics Ethernet network, the method comprising:
providing periodically a set of data messages, each comprising a set of data variables related to avionics functions,
transmitting at least one synchronization message onto the transmission medium,
detecting the beginning of at least one periodically repeating communication time frame comprising a plurality of time-slots of predetermined duration, based on the at least one synchronization message, and
in each system node to:
performing scheduled transmissions of said data packets, based on scheduling information relating to a timing table statically allocating to each of said plurality of time-slots a predetermined number of data packets, each comprising a predetermined subset of data messages from said set of data messages.

10. The method according to claim 9, further comprising in each system node:
performing scheduled retrieval of the data packets based on scheduling information relating to a timing table statically allocating to each of said plurality of time-slots a predetermined number of data packets, each comprising a predetermined subset of data messages from said set of data messages.

11. The method according to claim 10, further comprising in each system node to:
transmitting the data packets along two independent paths formed in the network, based on a plurality of traffic control modules.

12. The method according to claim 11, further comprising in each system node:
filtering the data packets received via the two independent paths in order to retrieve one correct copy of each of the data packets.

13. A computer program product, comprising:
a non-transitory computer readable medium; and
a program code recorded on the computer readable medium for performing, when said computer programme is run on a computer a method for controlling transmissions in an avionics Ethernet network, the method comprising
providing periodically a set of data messages, each comprising a set of data variables related to avionics functions,
transmitting at least one synchronization message onto the transmission medium,
detecting the beginning of at least one periodically repeating communication time frame comprising a plurality of time-slots of predetermined duration, based on the at least one synchronization message, and
in each system node:
performing scheduled transmissions of said data packets, based on scheduling information relating to a timing table statically allocating to each of said plurality of time-slots a predetermined number of data packets, each comprising a predetermined subset of data messages from said set of data messages.

14. (canceled)

15. (canceled)
